(19) United States
(12) Patent Application Publication
(10) Pub. No.: US 2017/0083891 A1
(43) Pub. Date: Mar. 23, 2017

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Akihiro Moro, Sunto (JP)

(21) Appl. No.: 14/856,642

(22) Filed: Sep. 17, 2015

(51) Int. Cl. G06Q 20/20; G06F 3/0488; G08B 3/10; G06K 9/62

(52) U.S. Cl. CPC G06Q 20/208; G06K 9/6215; G06F 3/0488; G08B 3/1008; G06K 2209/17

(57) ABSTRACT

In general, according to one embodiment, an information processing apparatus includes an extracting unit, a first display control unit, a first input receiving unit, a second display control unit, a second input receiving unit, and an output unit. The extracting unit extracts candidates for a commodity subjected to image pickup. The first display control unit selectably displays the commodity candidates. The first input receiving unit receives selection of a commodity candidate out of the commodity candidates. The second display control unit displays a screen for indicating which commodity candidate is selected and receiving a decision input of the commodity candidate. The second input receiving unit receives the decision input of the commodity candidate. The output unit outputs information concerning the commodity candidate decided by the decision input of the commodity candidate received by the second input receiving unit.

### FIELD

Embodiments described herein relate generally to a commodity deciding technique employing object recognition in a checkout system.

### BACKGROUND

There has been a checkout system including a commodity reading apparatus that reads a barcode and a discount sticker and a POS terminal that automatically processes a purchase commodity name, a price, and a discount on the basis of read data.

As the checkout system, there is a checkout system that picks up an image of a commodity to which a barcode or a discount sticker cannot be stuck and extracts a plurality of candidates for the commodity according to object recognition processing. The checkout system displays the extracted plurality of candidates on a display for a register store clerk and causes the register store clerk to select a target commodity out of the plurality of candidates.

However, in the checkout system, if a target commodity is outside of the store clerk's area of expertise, the store clerk needs to orally confirm with a purchaser which one of commodity candidates the target commodity is or confirm a person in charge of a commodity display area about the target commodity. As a result, register processing takes a long time.

### DESCRIPTION OF THE DRAWINGS

FIG. 1 is a perspective view showing a checkout system;

FIG. 2 is a block diagram showing hardware configurations of a POS terminal and a commodity reading apparatus;

FIG. 3 is a conceptual diagram showing a data configuration of a PLU file;

FIG. 4 is a conceptual diagram showing a data configuration of a notification condition file;

FIG. 5 is a functional block diagram of the POS terminal and the commodity reading apparatus;

FIG. 6 is a flowchart of commodity identification processing by the commodity reading apparatus;

FIG. 7 is a diagram showing a frame image displayed on a touch panel for store clerk;

FIG. 8 is a diagram showing a decision screen;

FIG. 9 is a diagram showing a confirmation screen;

FIG. 10 is a flowchart of commodity candidate processing;

FIG. 11 is a diagram showing a selection screen;

FIG. 12 is a diagram showing a selection screen displayed on a touch panel for purchaser;

FIG. 13 is a diagram showing a selection result display screen;

FIG. 14 is a diagram showing a change confirmation screen; and

FIG. 15 is a diagram showing a selection result display screen.

### DETAILED DESCRIPTION

In general, according to one embodiment, an information processing apparatus includes an extracting unit, a first display control unit, a first input receiving unit, a second display control unit, a second input receiving unit, and an output unit. The extracting unit extracts, on the basis of similarities between an image of a commodity picked up by an image pickup unit and reference images of commodities, candidates for the commodity subjected to the image pickup. The first display control unit selectably displays the commodity candidates on a display for purchaser. The first input receiving unit receives selection of a commodity candidate out of the commodity candidates via a first operation unit. The second display control unit displays, on a display for store clerk different from the display for purchaser, a screen for indicating which commodity candidate is selected and receiving a decision input of the commodity candidate. The second input receiving unit receives the decision input of the commodity candidate via a second operation unit different from the first operation unit. The output unit outputs information concerning the commodity candidate decided by the decision input of the commodity candidate received by the second input receiving unit.

In general, according to another embodiment, there is provided an information processing method comprising: extracting, on the basis of similarities between an image of a commodity picked up by an image pickup unit and reference images of commodities, candidates for the commodity subjected to the image pickup; selectably displaying the commodity candidates on a display for purchaser; receiving selection of a commodity candidate out of the commodity candidates via a first operation unit; displaying, on a display for store clerk different from the display for purchaser, a screen for indicating which commodity candidate is selected and receiving a decision input of the commodity candidate; receiving the decision input of the commodity candidate via a second operation unit different from the first operation unit; and outputting information concerning the commodity candidate decided by the received decision input of the commodity candidate.

An embodiment is explained below with reference to the drawings.

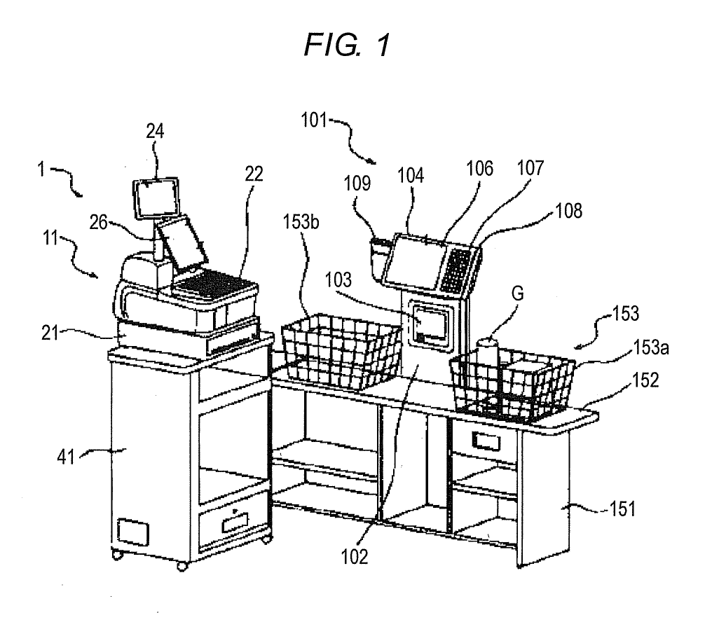

FIG. 1 is a perspective view showing a checkout system 1.

The checkout system 1 includes a commodity reading apparatus 101 (an information processing apparatus) that reads information concerning a commodity and a POS terminal 11 that performs registration and settlement of commodities in each transaction.

The POS terminal 11 is present on a checkout table 41. The POS terminal 11 includes a drawer 21, a keyboard 22, a touch panel for store clerk 26, and a touch panel for purchaser 24. The touch panel for store clerk 26 faces the inner side of the checkout table 41 and a counter table 151 that form an L shape. The touch panel for store clerk 26 displays information to a store clerk and performs input reception. The touch panel for purchaser 24 can rotate the direction thereof to a store clerk side, which is a near side in FIG. 1, or a purchaser side, which is a depth side in FIG. 1.

The counter table 151 is arranged such that the counter table 151 and the checkout table 41 form an L shape. A loading surface 152 is present on the upper surface of the counter tale 151. A first shopping basket 153a carried in by a purchaser and a second shopping basket 153b located in a position across the commodity reading apparatus 101 from the first shopping basket 153a are placed on the loading surface 152.

The commodity reading apparatus 101 connected to the POS terminal 11 to be capable of transmitting and receiving data is attached to the counter table 151. The commodity reading apparatus 101 includes a thin rectangular housing 102. The housing 102 includes a reading window 103 that faces the store clerk side. A display and operation unit 104 is present above the housing 102. The display and operation unit 104 includes a touch panel for store clerk 106 (a second display unit and a second operation unit), a keyboard 107, and a card reading groove section 108 for a not-shown card reader. The touch panel for store clerk 106 faces the inner side of the checkout table 41 and the counter table 151, which form the L shape. The touch panel for store clerk 106 displays information to the store clerk and performs input reception.

The commodity reading apparatus 101 includes a touch panel for purchaser 109 (a first display unit and a first operation unit) present on the left depth side in FIG. 1 of the display and operation unit 104. The touch panel for purchaser 109 faces the opposite side of the touch panel for store clerk 106. The touch panel for purchaser 109 displays information to the purchaser and performs input reception.

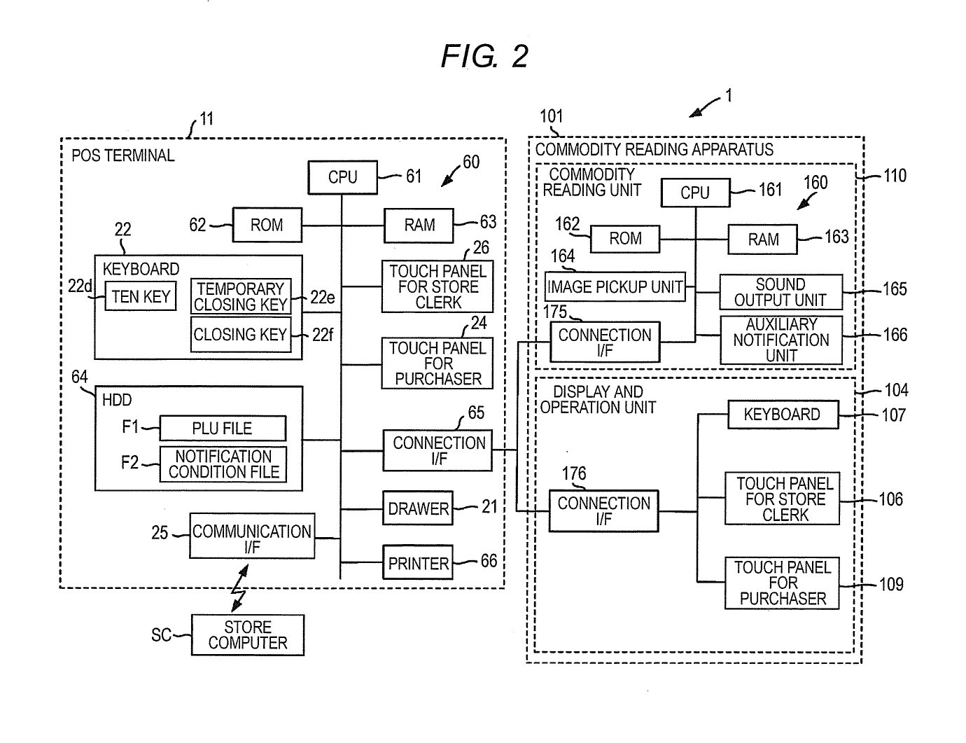

The commodity reading apparatus 101 includes a commodity reading unit 110 (see FIG. 2). The commodity reading unit 110 includes an image pickup unit 164 (see FIG. 2) present on the depth side of the reading window 103.

A register store clerk (hereinafter described as store clerk) takes out a commodity G from the first shopping basket 153a, turns the commodity to the reading window 103, and, after causing the image pickup unit 164 to pick up an image of the commodity G, transfers the commodity G to the second shopping basket 153b.

The commodity reading apparatus 101 determines which commodity candidate registered in a below-mentioned PLU file F1 (see FIG. 2) the commodity G corresponds to. If there are a plurality of commodity candidates having similar appearances or if there are a plurality of commodity candidates having the same appearance and different prices or producing districts and one commodity candidate is not decided, the commodity reading apparatus 101 displays, on the touch panel for purchaser 109, a screen for causing the purchaser to designate a commodity.

When the purchaser selects a commodity candidate as the purchase commodity G out of a plurality of commodity candidates on the touch panel for purchaser 109, the commodity reading apparatus 101 displays, on the touch panel for store clerk 106, a screen on which the commodity candidate selected by the purchaser can be decided as the commodity G. If there is no problem in the commodity candidate designated by the purchaser, the store clerk decides the commodity candidate as the commodity G on the screen. If the store clerk determines that the commodity candidate designated by the purchaser is not the actual commodity G, the store clerk selects another commodity candidate and decides the commodity candidate as the commodity G. The commodity reading apparatus 101 outputs a commodity ID of the commodity candidate decided as the commodity G by the store clerk to the POS terminal 11.

The POS terminal 11 records, on the basis of the commodity ID output by the commodity reading apparatus 101, information related to sales registration such as a commodity classification, a commodity name, and a unit price of a commodity corresponding to the commodity ID in a sales master file and performs the sales registration.

FIG. 2 is a block diagram showing hardware configurations of the POS terminal 11 and the commodity reading apparatus 101.

The POS terminal 11 includes a microcomputer 60 functioning as an information processing unit configured to execute information processing. The microcomputer 60 includes a CPU (Central Processing Unit) 61 configured to execute various kinds of arithmetic processing and control units, a ROM (Read Only Memory) 62, a RAM (Random Access Memory) 63, and a HDD (Hard Disk Drive) 64. The CPU 61 controls the drawer 21, the keyboard 22, the touch panel for store clerk 26, the touch panel for purchaser 24, and a printer 66. The HDD 64 stores a PLU (Price Look Up) file F1 and a notification condition file F2 distributed by a store computer SC.

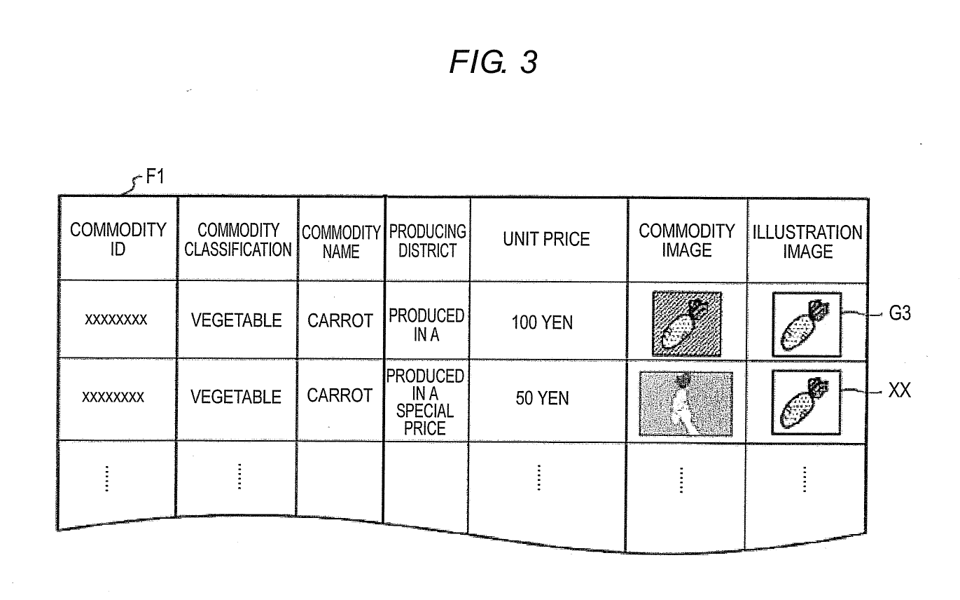

FIG. 3 is a conceptual diagram showing a data configuration of the PLU file F1.

In the PLU file F1, concerning each of commodities G, information concerning sales registration of the commodity G such as a commodity ID, a commodity classification, a commodity name, a producing district, and a unit price, a picked-up image (a reference image) of the commodity G, and an illustration image of the commodity G are associated with one another. The picked-up image of the commodity G is used for determination of similarity. In this embodiment, when a commodity is discounted with respect to the same commodity and sold, information indicating the discount, for example, “special price” is input to a producing district field. However, an exclusive input field indicating a discount may be provided in the PLU file F1. In the PLU file F1, feature values such as a tint and an unevenness state of a surface read from a commodity image may be associated with each of commodities.

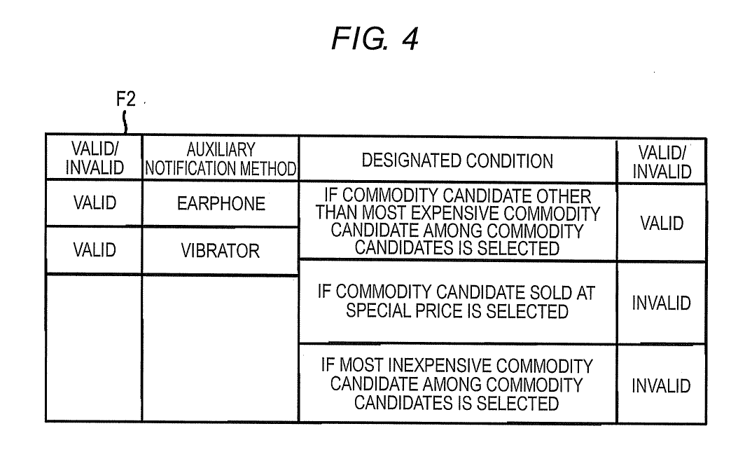

FIG. 4 is a conceptual diagram showing a data configuration of the notification condition file F2.

In this embodiment, if one commodity candidate is not decided, a selection screen for a commodity candidate is displayed on the touch panel for purchaser 109 to cause a purchaser to select which commodity candidate a purchase commodity is. Incidentally, for example, there are commodities having substantially the same appearances and different prices. For example, as “carrot”, there are “carrot” “produced in A” sold at a normal price and “carrot” “produced in A, special price” sold at a price lower than the normal price. In such a case, although a purchase commodity is “carrot” “produced in A” sold at the normal price, it is likely that the purchaser selects “carrot” “produced in A, special price” as a commodity candidate.

Therefore, a designated condition for notification to the store clerk is stored in the notification condition file F2. When the purchaser selects a commodity candidate matching the designated condition, the commodity reading apparatus 101 displays, on the touch panel for store clerk 106, a screen for notifying the store clerk that the purchaser selects the commodity candidate matching the designated condition.

In this embodiment, the designated condition is set to “if a commodity candidate other than a most expensive commodity candidate among commodity candidates is selected”. As the designated condition, there are, for example, “if a commodity candidate having a special price is selected” and “if a commodity candidate having a lowest price among commodity candidates is selected”.

Setting of a method in which the commodity reading apparatus 101 gives auxiliary notification to the store clerk together with notification screen display on the touch panel for store clerk 106 is stored in the notification condition file F2. In this embodiment, it is assumed that notification by an earphone or a vibrator is set as the auxiliary notification method.

Referring back to FIG. 2, the CPU 61 of the POS terminal 11 is connected to a communication interface 25 for executing data communication with the store computer SC. The store computer SC is present in a backyard or the like of a store. A not-shown HDD of the store computer SC stores the PLU file F1 and the notification condition file F2. The store computer SC performs setting of the PLU file F1 and the notification condition file F2 and distributes the files F1 and F2 to the POS terminal 11. The store clerk can change the setting of the PLU file F1 and the notification condition file F2 as appropriate in the store computer SC. The CPU 61 is also connected to a connection interface 65 for executing data transmission and reception between the CPU 61 and the commodity reading apparatus 101. The connection interface 65 is connected to the commodity reading apparatus 101.

The commodity reading apparatus 101 includes a microcomputer 160. In the microcomputer 160, a CPU 161 is connected to a ROM 162 and a RAM 163 by a bus. The ROM 162 has stored therein a computer program executed by the CPU 161. The CPU 161 is connected to an image pickup unit 164, a sound output unit 165, and an auxiliary notification unit 166 and controls the components 164 to 166. The image pickup unit 164 is a color CCD (Charge Coupled Device) or the like. The image pickup unit 164 picks up an image of a commodity at 30 fps from the reading window 103. The RAM 163 stores frame images (picked-up images) sequentially picked up by the image pickup unit 164. The sound output unit 165 is a speaker. The sound output unit 165 performs notification by warning sound or sound. The auxiliary notification unit 166 is an earphone or a vibrator worn by the store clerk. The auxiliary notification unit 166 performs notification to the store clerk by sound or vibration.

The CPU 161 is connected to a connection interface 175 for performing data communication with the POS terminal 11. The CPU 161 also performs data communication with the display and operation unit 104 via the connection interface 175. The display and operation unit 104 is connected to the commodity reading unit 110 and the POS terminal 11 via a connection interface 176.

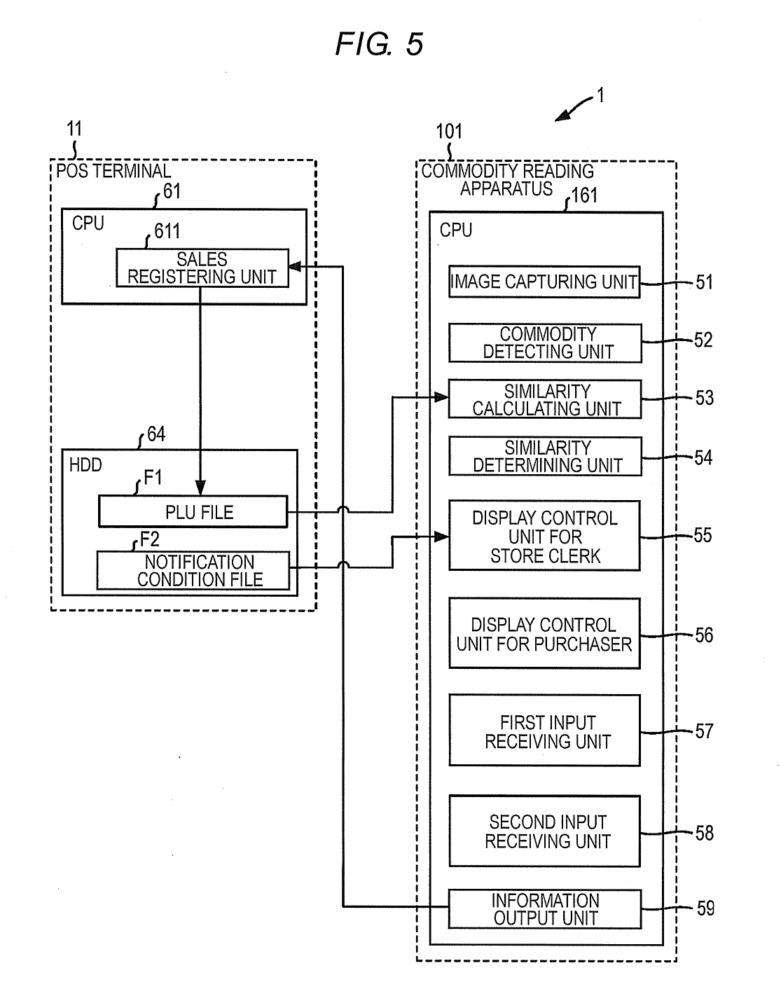

FIG. 5 is a functional block diagram of the POS terminal 11 and the commodity reading apparatus 101.

Functional configurations of the CPUs 161 and 61 realized by the CPUs 161 and 61 executing computer programs are explained.

The CPU 161 of the commodity reading apparatus 101 executes the computer program stored by the ROM 162 to thereby acquire functions of an image capturing unit 51, a commodity detecting unit 52, a similarity calculating unit 53, a similarity determining unit 54, a display control unit for store clerk 55 (a second display control unit), a display control unit for purchaser 56 (a first display control unit), a first input receiving unit 57, a second input receiving unit 58, and an information output unit 59. The CPU 61 of the POS terminal 11 executes the computer program stored by the ROM 62 or the HDD 64 to thereby acquire a function of a sales registering unit 611.

Explanation of the components is given below together with explanation of commodity identification processing by the commodity reading apparatus 101.

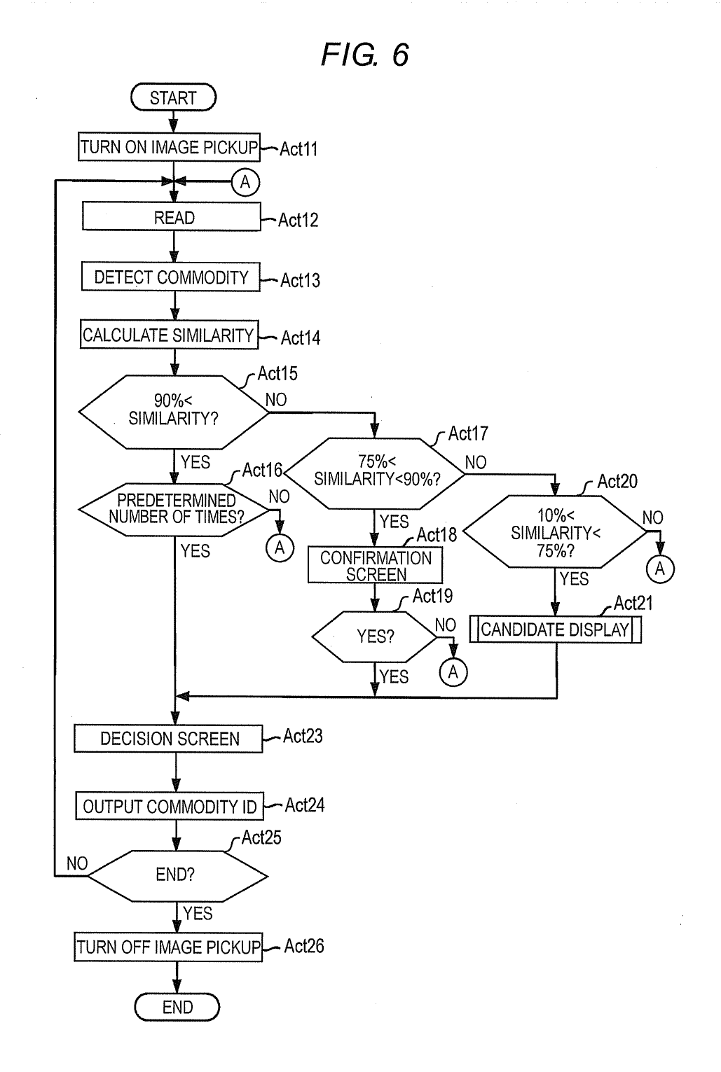

FIG. 6 is a flowchart of the commodity identification processing by the commodity reading apparatus 101.

The image capturing unit 51 causes the image pickup unit 164 to pick up an image (Act 11) and sequentially captures frame images sequentially stored by the RAM 163 from the RAM 163 (Act 12).

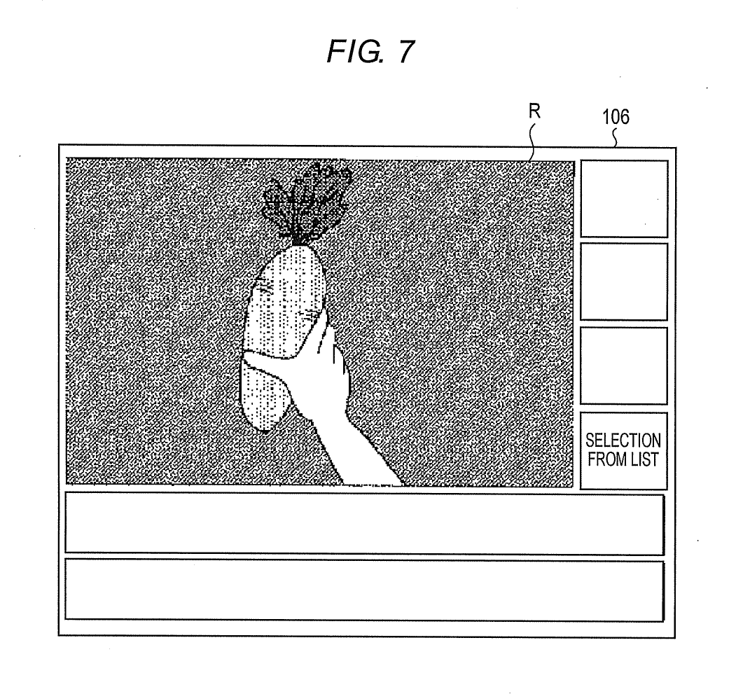

FIG. 7 is a diagram showing a frame image R captured by the image capturing unit 51 and displayed on the touch panel for store clerk 106.

In Act 12, the display control unit for store clerk 55 displays a frame image, which is obtained by picking up an image of the commodity G, on the touch panel for store clerk 106 and updates the frame image at an appropriate interval.

The commodity detecting unit 52 detects, using a pattern matching technique or the like, all or a part of the commodity G included in the frame image R captured by the image capturing unit 51 (Act 13). Specifically, the commodity detecting unit 52 extracts a contour line or the like of the commodity G from an image obtained by binarizing the captured frame image R. Subsequently, the commodity detecting unit 52 compares a contour line extracted from the last frame image and the contour line extracted from the present frame image to detect the commodity G included in the frame image R.

The similarity calculating unit 53 reads, as feature values, a tint of the commodity G and a state of a surface such as an unevenness state of the surface of the commodity G from the image of the commodity G picked up by the image pickup unit 164. The similarity calculating unit 53 does not take into account the contour and the size of the commodity G in order to reduce a processing time.

The similarity calculating unit 53 reads, from a commodity image of each of commodities registered in the PLU file F1 (hereinafter referred to as registered commodities), as feature values, a tint of the registered commodity and a state of a surface such as an unevenness state of the surfaces, respectively compares the feature values with the feature values of the commodity G to calculate similarity of the commodity G and the registered commodity of the PLU file F1 (Act 14). The similarity indicates, when the similarity of each of the commodity images of the PLU file F1 is assumed to be 100%=“similarity: 1.0”, to which degree the image of the commodity G is similar to each of the commodity images. Documents 1 and 2 described below explain such generic object recognition. As a basic configuration of this embodiment, the configuration disclosed in Japanese Patent No. 5194160 can be adopted.
Document 1: Keiji Yanai, “Present Situation and Future of Generic Object Recognition”, The Information Processing Society of Japan Transaction, Vol. 48, No. SIG16 [retrieved on Aug. 10, 2010], Internet <URL: http://mm.cs.uec.ac.jp/IPSJ-TCVIM-Yanai.pdf>
Document 2: Jamie Shotton et al., “Semantic Texton Forests for Image Categorization and Segmentation”, [retrieved on Aug. 10, 2010], Internet <URL: http://citeseerx.ist.psu.edu/viewdoc/download?doi=10.1.1.1 45.3036&rep=rep1&type=pdf>

If similarity is calculated by an absolute evaluation, a picked-up image of the commodity G and the commodity image of each of the registered commodities of the PLU file F1 are compared one to one and derived similarity may be adopted. If similarity is calculated by a relative evaluation, the similarity of each of the registered commodities may be calculated such that a sum of the similarities of the registered commodities of the PLU file F1 is 1.0 (100%).

The similarity determining unit 54 determines, for each of frame images narrowed down by the image capturing unit 51, which of below-described conditions “a” to “c” the similarity of each of the registered commodities of the PLU file F1 satisfies and decides the registered commodity corresponding to the commodity G or extracts the registered commodity as a commodity candidate (Acts 15 to 17 and Act 20).

“An extracting unit configured to extract, on the basis of similarities between an image of a commodity picked up by an image pickup unit and reference images of commodities, candidates for the commodity subjected to the image pickup” is configured including the similarity calculating unit 53 and the similarity determining unit 54.

The similarity determining unit 54 decides the registered commodity of the PLU file F1 satisfying the condition “a” or the condition “b” as a commodity corresponding to the commodity G subjected to the image pickup. The similarity determining unit 54 extracts, as a candidate for the commodity G subjected to the image pickup, the registered commodity of the PLU file F1 satisfying the condition “c”. The conditions “a” to “c” are set according to first to third thresholds, a magnitude relation of which is the first threshold>the second threshold>the third threshold.

The similarity determining unit 54 counts the number of times the similarity of the registered commodity is determined as equal to or larger than the first threshold (e.g., 90%) (Act 15: YES). If the number of times of the determination is equal to or larger than a predetermined number of times, the similarity determining unit 54 determines that the registered commodity satisfies the condition “a” (Act 16: YES). If the first threshold is set sufficiently high to prevent a determination mistake, the predetermined number of times may be one.

If the similarity of the registered commodity is smaller than the first threshold (e.g., 90%) and equal to or larger than the second threshold (e.g., 75%), the similarity determining unit 54 determines that the registered commodity satisfies the condition “b” (Act 17: YES). The similarity determining unit 54 determines that the registered commodity satisfying the condition “b” is a decided commodity but confirmation operation by the store clerk is necessary. If the number of times the registered commodity satisfies the condition “b” is equal to or larger than the predetermined number of times, the similarity determining unit 54 may determine that the registered commodity satisfies the condition “b”.

If the similarity of the registered commodity is smaller than the second threshold (e.g., 75%) and equal to or larger than the third threshold (e.g., 10%), the similarity determining unit 54 determines that the registered commodity satisfies the condition “c” (Act 17: NO, Act 20: YES). If the number of times the registered commodity satisfies the condition “c” is equal to or larger than the predetermined number of times, the similarity determining unit 54 may determine that the registered commodity satisfies the condition “c”.

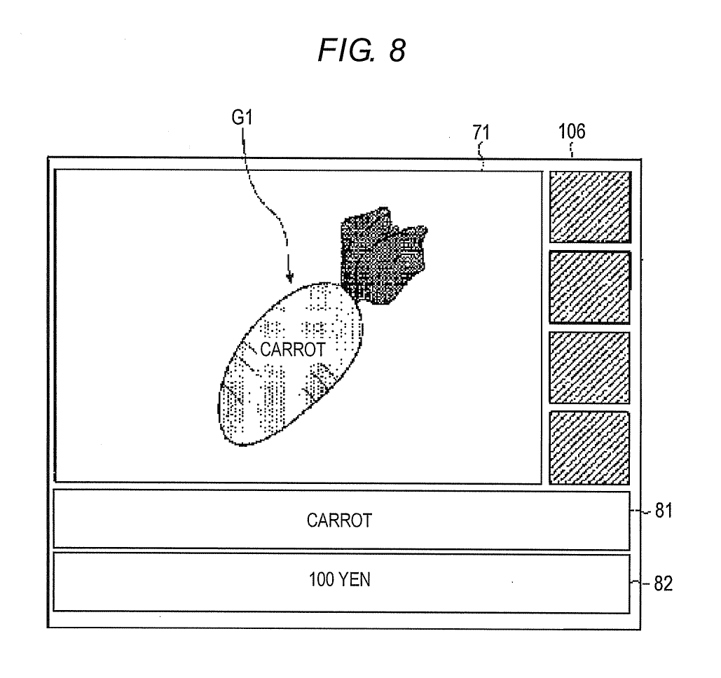

FIG. 8 is a diagram showing a decision screen 71.

When the commodity G is decided, the display control unit for store clerk 55 reads out an illustration image G1 and a commodity name “carrot” of the registered commodity corresponding to the commodity G from the PLU file F1 and displays the decision screen 71 including the illustration G1 and the commodity name “carrot” on the touch panel for store clerk 106 (Act 23). The display control unit for store clerk 55 displays, in a commodity name display area 81 and a price display area 82, a commodity name and a unit price (a commodity price) of the registered commodity read out from the PLU file F1 and decided as the commodity G subjected to the image pickup. The display control unit for store clerk 55 may display the commodity image read out from the PLU file F1 instead of the illustration image G1.

The display control unit for store clerk 55 notifies, according to timing of the display of the decision screen 71, with the sound output unit 165, the store clerk and the purchaser of information concerning the decided commodity such as the commodity name read out from the PLU file F1 (Act 23).

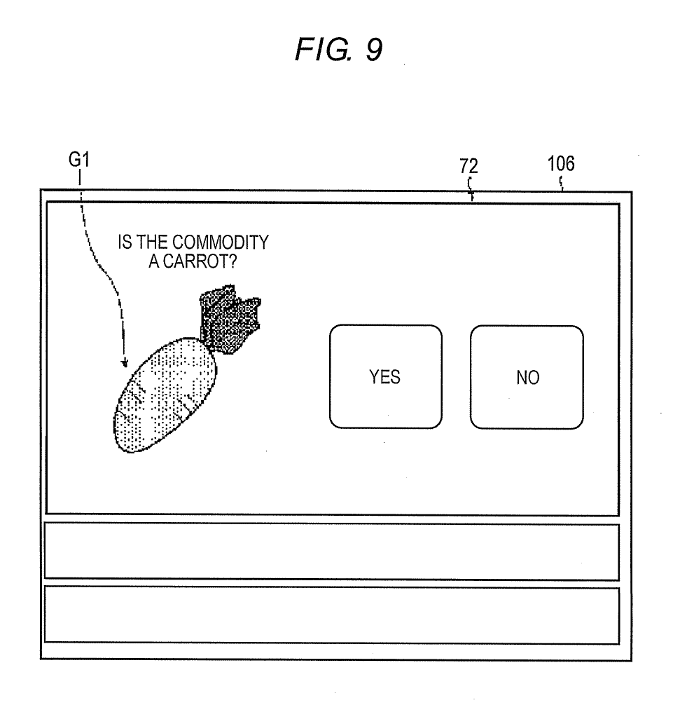

FIG. 9 is a diagram showing a confirmation screen 72.

The display control unit for store clerk 55 displays, on the touch panel for store clerk 106, the confirmation screen 72 for receiving final confirmation operation for confirming whether the registered commodity satisfying the condition “b” is the commodity G subjected to the image pickup (Act 18). The display control unit for store clerk 55 reads out the illustration image G1 from the PLU file F1 and displays the illustration image G1 in the confirmation screen 72.

The display control unit for store clerk 55 displays, using the commodity name of the decided commodity read out from the PLU file F1, a message for inquiring whether the commodity G subjected to the image pickup is the commodity of the illustration image G1, for example, “Is the commodity a carrot?”. The display control unit for store clerk 55 selectively displays buttons of “Yes/No” or the like on the confirmation screen 72.

If the button of “Yes” is operated (Act 19: YES), the display control unit for store clerk 55 displays the decision screen 71 shown in FIG. 8 on the touch panel for store clerk 106 (Act 23).

If the similarity of the registered commodity is smaller than the second threshold (e.g., 75%) and equal to or larger than the third threshold (e.g., 10%), the similarity determining unit 54 determines that the registered commodity satisfies the condition “c” (Act 20: YES). In this case, the CPU 161 executes commodity candidate processing (Act 21) explained below.

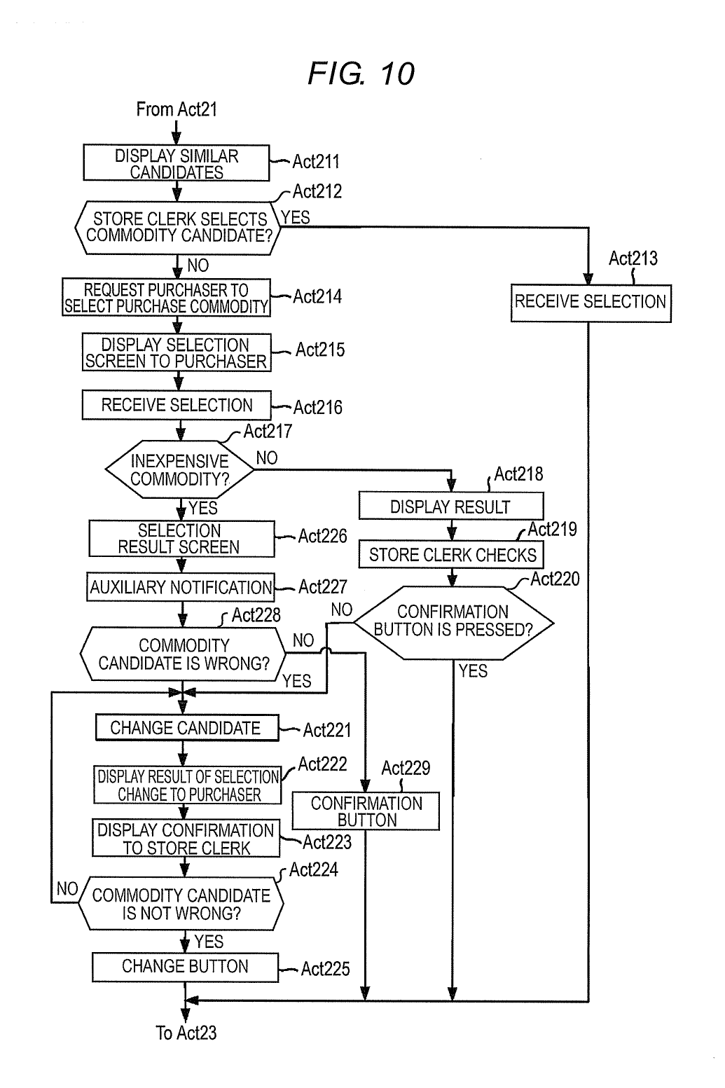

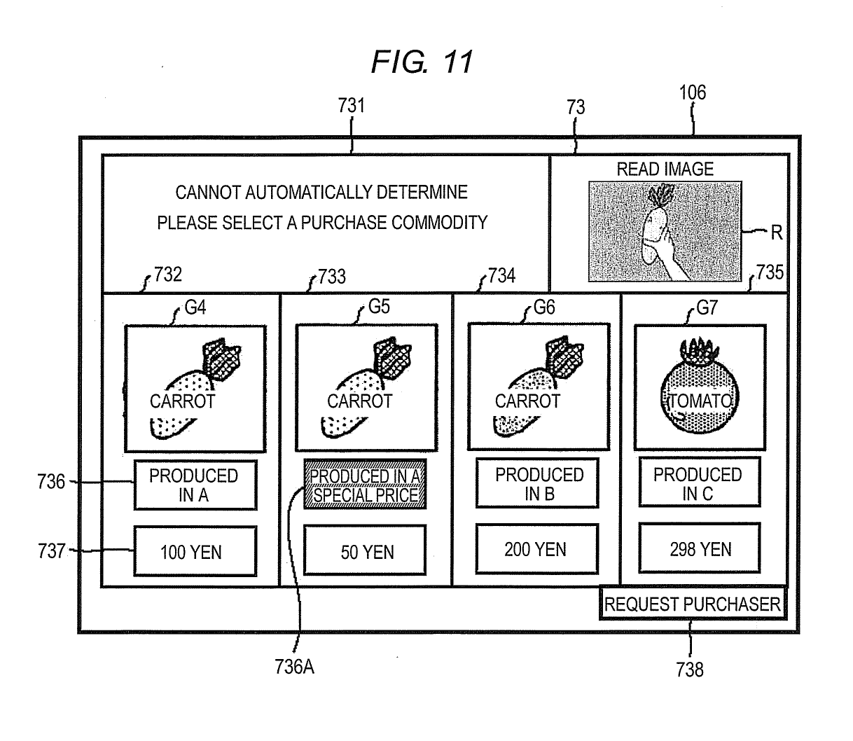

FIG. 10 is a flowchart of the commodity candidate processing. FIG. 11 is a diagram showing a selection screen 73.

The display control unit for store clerk 55 displays, on the touch panel for store clerk 106, the selection screen 73 capable of receiving selection of a commodity candidate and capable of receiving an instruction for screen display for causing the purchaser to select the commodity candidate (Act 211).

In Act 211, the display control unit for store clerk 55 reads out commodity names, producing districts, illustration images, and unit prices of commodities satisfying the condition “c” from the PLU file F1. The display control unit for store clerk 55 displays, on the selection screen 73, a message field 731 and the picked-up image frame R in an upper part and displays information display fields 732 to 735 and a selection request button 738 for the purchaser in a lower part. The display control unit for store clerk 55 displays, in the message field 731, a message for urging the store clerk to select commodity candidates corresponding to the purchase commodity G.

The display control unit for store clerk 55 displays the information display fields 732 to 735 for the registered commodities from the left side in FIG. 11 in the order of similarities of the registered commodities. In this embodiment, the information display fields 732 to 735 for displaying, as the registered commodities, carrot produced in A sold at a price of 100 yen, carrot produced in A sold at a special price of 50 yen, carrot produced in B sold at a price of 200 yen, and tomato produced in C sold at a price of 298 yen are displayed from the left side in FIG. 11 in this order.

The information display fields 732 to 735 include images G4 to G7 obtained by merging the illustrations and the commodity names of the registered commodities satisfying the condition “c”, producing district indications 736 of the registered commodities, and unit price indications 737 of the registered commodities. If information indicating a discount such as a special price is included in the producing district, the display control unit for store clerk 55 displays a producing district indication 736A highlighted by changing a color to call attention. The information display fields 732 to 735 are selectively displayed.

The second input receiving unit 58 receives inputs by the touch panel for store clerk 106 and the keyboard 107. The first input receiving unit 57 receives an input by the touch panel for purchaser 109.

In this embodiment, if the store clerk can select a commodity candidate even if a plurality of commodity candidates are displayed on the selection screen 73 (Act 212: YES), the store clerk selects, with the touch panel for store clerk 106 or the keyboard 107, the information display fields 732 to 735 of a commodity candidate to be decided as the commodity G (Act 213).

When the second input receiving unit 58 receives the selection of the information display fields 732 to 735 by the store clerk (Act 213), the display control unit for store clerk 55 decides the selected commodity candidate as the commodity G and displays the decision screen 71 shown in FIG. 8 on the touch panel for store clerk 106 (Act 23).

If a plurality of similar commodities (commodities having similar appearances) are displayed on the selection screen 73 as shown in FIG. 11, a store clerk such as a side-worker or a part-timer not having expertise concerning a target commodity G sometimes cannot select a commodity candidate (Act 212: NO). In this case, the store clerk selects a selection request button 738 for the purchaser in order to request the purchaser to select the purchase commodity G (Act 214).

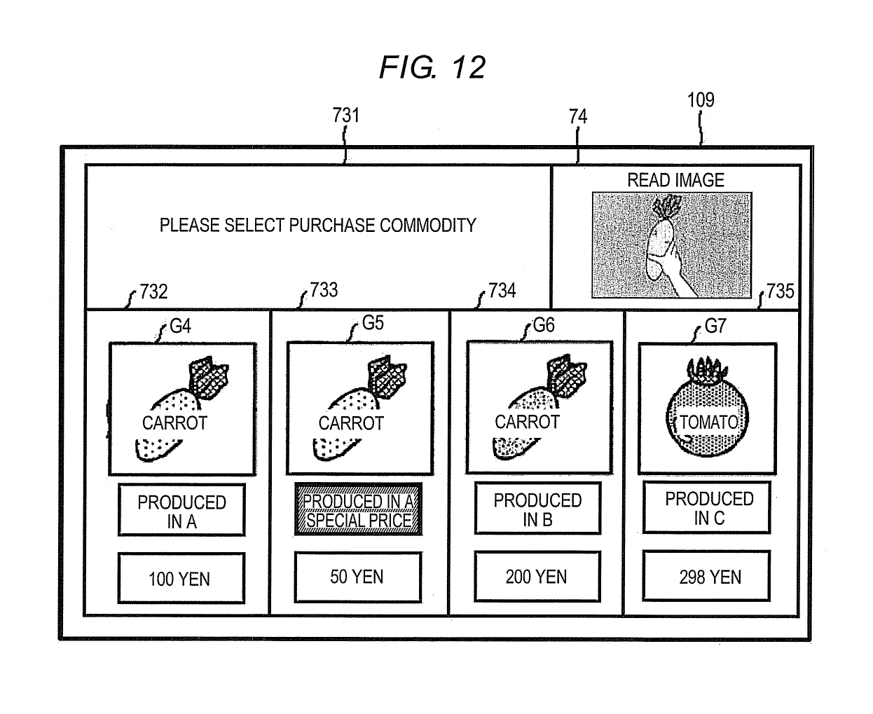

FIG. 12 is a diagram showing a selection screen 74 displayed on the touch panel for purchaser 109.

When the second input receiving unit 58 receives an input of the selection request button 738 (Act 214), the display control unit for purchaser 56 displays the selection screen 74 shown in FIG. 12 same as the selection screen 73 shown in FIG. 11 on the touch panel for purchaser 109 (Act 215).

The first input receiving unit 57 receives the selection of the information display fields 732 to 735 by the purchaser on the touch panel for purchaser 109 (Act 216).

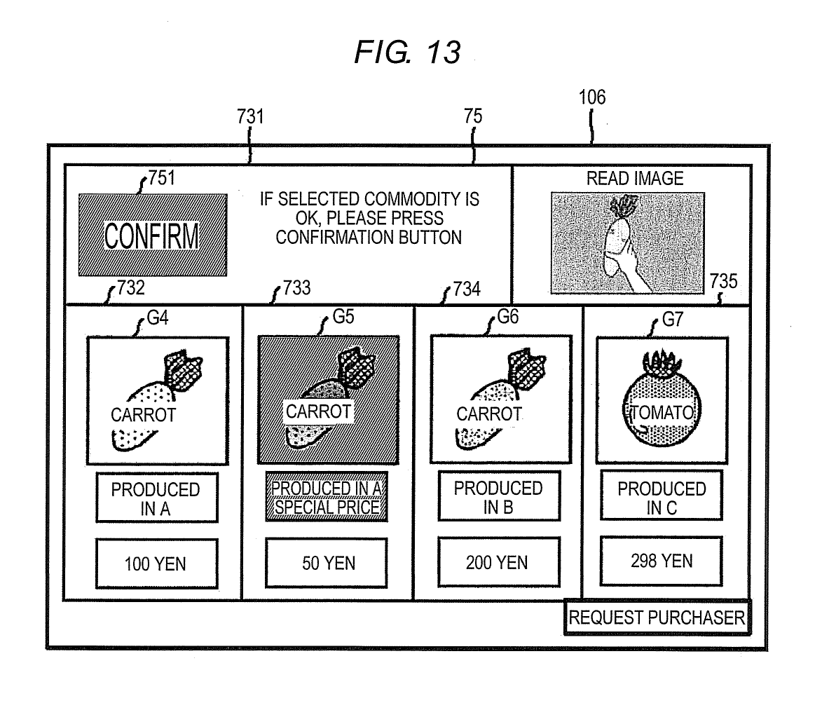

FIG. 13 is a diagram showing a selection result display screen 75 displayed when a commodity candidate not satisfying a designated condition is selected.

The display control unit for store clerk 55 reads the notification condition file F2. If the selection of the commodity candidate by the purchaser does not satisfy the designated condition “if a commodity candidate other than a most expensive commodity candidate among commodity candidates is selected” in this embodiment (Act 217: NO), the display control unit for store clerk 55 displays the selection result display screen 75 on which a selection result of the purchaser is displayed by, for example, highlighting any one of the images G4 to G7 or the information display fields 732 to 735 of the selected commodity candidate (Act 218). On the selection result display screen 75, a confirmation button 751 and a message to the effect that “please press the confirmation button 751 in order to decide the selection of the commodity candidate of the purchaser” are displayed in the message field 731 in the selection screen 73 shown in FIG. 11. The display control unit for store clerk 55 causes the confirmation button 751 to blink.

The store clerk checks the selected commodity candidate (Act 219) and operates the confirmation button 751 if there is no particular problem.

When the second input receiving unit 58 receives the operation of the confirmation button 751 (Act 220: YES), the display control unit for store clerk 55 decides, as the commodity G, the commodity candidate selected by the purchaser and displays a confirmation screen 71 shown in FIG. 8 on the touch panel for store clerk 106 (Act 23).

When the commodity candidate selected by the purchaser is wrong (Act 220: NO), the store clerk selects a correct commodity candidate on the touch panel for store clerk 106 (Act 221).

When, for example, any one of the information display fields 732 to 735 is depressed and the selection of any one of the commodity candidates by the store clerk is received (Act 221), the display control unit for purchaser 56 reflects a result of the selection change of the commodity candidate by the store clerk on the screen 74 on the touch panel for purchaser 109 (Act 222). The display control unit for purchaser 56 reflects the result of the selection change of the commodity candidate by the store clerk by, for example, changing a color of any one of the information display fields 732 to 735 of the selected commodity candidate.

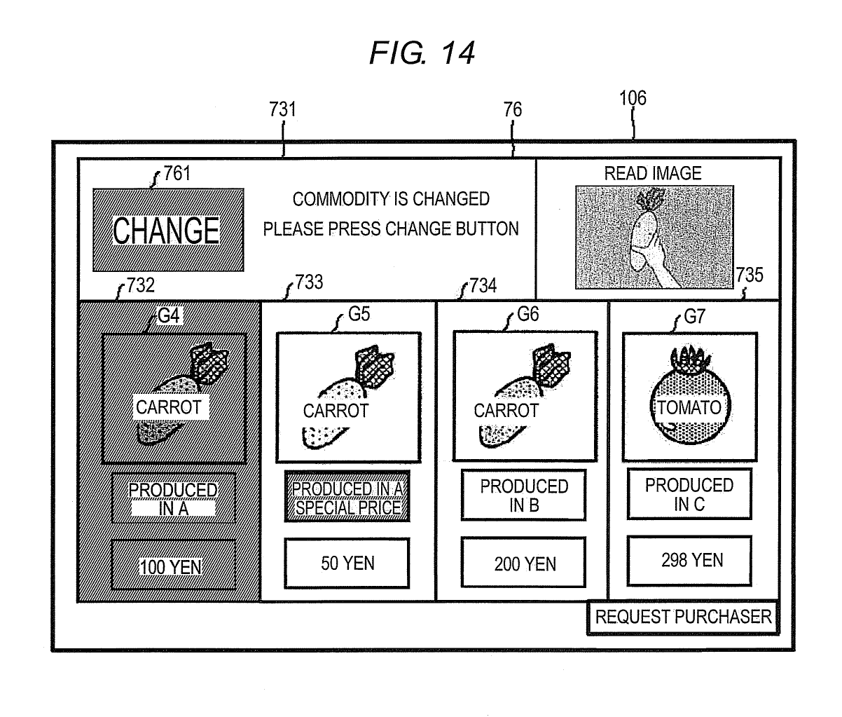

FIG. 14 is a diagram showing a change confirmation screen 76 displayed when the store clerk changes the commodity candidate selected by the purchaser.

When the selection of the commodity candidate by the store clerk is received (Act 221), the display control unit for store clerk 55 displays a change button 761 and a message to the effect that “please press the change button 761 in order to decide the change” in the message field 731 (Act 223). The display control unit for store clerk 55 causes the change button 761 to blink.

When the changed commodity candidate is not wrong (Act 224: YES), the store clerk operates the change button 761 (Act 225).

Upon receiving the operation of the change button 761 (Act 225), the display control unit for store clerk 55 decides the changed commodity candidate as the commodity G and displays the decision screen 71 shown in FIG. 8 on the touch panel for store clerk 106 (Act 23).

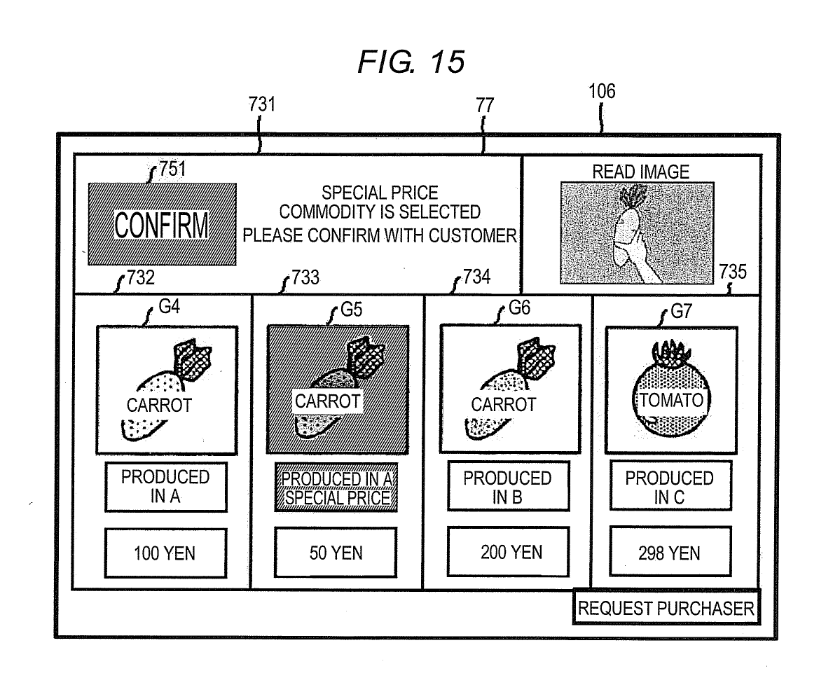

FIG. 15 is a diagram showing a selection result display screen 77 displayed when the commodity candidate satisfying the designated condition is selected by the purchaser.

If the selection of the purchaser performed on the touch panel for purchaser 109 satisfies the designated condition “if a commodity candidate other than a most expensive commodity candidate among commodity candidates is selected” (Act 217: YES), the display control unit for store clerk 55 displays the selection result display screen 77 showing a selection result of the purchaser (Act 226). On the selection result display screen 77, the confirmation button 751 and a message indicating to the effect that “an inexpensive commodity, which is not a most expensive commodity candidate, is selected by the purchaser” are displayed in the message field 731 in the selection screen 73 shown in FIG. 11. On the selection result display screen 77, the confirmation button 751 is caused to blink.

By controlling the auxiliary notification unit 166 in addition to the screen display, the display control unit for store clerk 55 auxiliarily notifies the store clerk that the inexpensive commodity, which needs to be watched, is selected (Act 227). For example, the display control unit for store clerk 55 sounds the earphone functioning as the auxiliary notification unit 166 or vibrates the vibrator functioning as the auxiliary notification unit 166.

The store clerk checks the selected commodity candidate and, if the commodity candidate is not wrong (Act 228: NO), operates the confirmation button 751 (Act 229).

Upon receiving the operation of the confirmation button 751 (Act 229), the display control unit for store clerk 55 decides, as the commodity G, the commodity candidate selected by the purchaser and displays the decision screen 71 shown in FIG. 8 on the touch panel for store clerk 106 (Act 23).

The store clerk checks the selected commodity candidate and, if the selected commodity candidate is wrong, selects a correct commodity candidate (Act 228: YES). In this case, Acts 221 to 225 are performed. A result of the selection change by the store clerk is reflected on the screen 74 on the touch panel for purchaser 109. The screen 76 shown in FIG. 14 for deciding the change is displayed on the touch panel for store clerk 106.

When the commodity candidate is decided in this way, the information output unit 59 outputs a commodity ID of the decided commodity candidate to the POS terminal 11 (Act 24).

When the commodity ID is output to the POS terminal 11, the image capturing unit 51 determines that the commodity identification processing ends (Act 25: YES). The image capturing unit 51 ends the image pickup by the image pickup unit 164 (Act 26).

In the commodity identification processing, an acquisition process for the number of sold items is omitted to facilitate understanding of the explanation. However, in the commodity reading apparatus 101, an input field for the number of sold items may be provided on the decision screen 71 shown in FIG. 8 in addition to the image G1 of the decided commodity. The commodity reading apparatus 101 may receive an input of the number of sold items via the touch panel 106 or the keyboard 107. The commodity reading apparatus 101 may notify the POS terminal 11 of the number of sold items together with the commodity ID and the like.

The sales registering unit 611 of the POS terminal 11 performs, on the basis of the commodity ID (and the number of sold items) notified by the information output unit 59, sales registration of a commodity corresponding to the commodity ID. The sales registering unit 611 records, referring to the PLU file F1, the notified commodity ID and a commodity classification, a commodity name, a unit price, and the like corresponding to the commodity ID in the sales master file or the like (together with the number of sold items) and performs sales registration.

In this embodiment, if the store clerk cannot narrow down commodity candidates of the purchase commodity G extracted by the object recognition processing, the commodity candidates can be displayed on the touch panel for purchaser 109 to request the purchaser to select a commodity candidate. Therefore, in this embodiment, it is possible to make it unnecessary for the store clerk to select a commodity candidate after orally confirming with the purchaser which commodity is a commodity candidate or moving to a display place of commodities and checking the commodities. As a result, it is possible to reduce time for register processing.

In this embodiment, if the store clerk determines that a commodity candidate selected by the purchaser is wrong, the store clerk can change the selection of the commodity candidate. Therefore, it is possible to prevent a wrong commodity candidate from being decided as the commodity G.

As explained above in detail, according to the technique described in this specification, it is possible to provide a commodity deciding technique employing object recognition in a checkout system.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. An information processing apparatus comprising:
an extracting unit configured to extract, on the basis of similarities between an image of a commodity picked up by an image pickup unit and reference images of commodities, candidates for the commodity subjected to the image pickup;
a first display control unit configured to selectably display the commodity candidates on a display for purchaser;
a first input receiving unit configured to receive selection of a commodity candidate out of the commodity candidates via a first operation unit;
a second display control unit configured to display, on a display for store clerk different from the display for purchaser, a screen for indicating which commodity candidate is selected and receiving a decision input of the commodity candidate;
a second input receiving unit configured to receive the decision input of the commodity candidate via a second operation unit different from the first operation unit; and
an output unit configured to output information concerning the commodity candidate decided by the decision input of the commodity candidate received by the second input receiving unit.

2. The apparatus according to claim 1, wherein, when the first input receiving unit received selection of a commodity candidate matching a designated condition out of the commodity candidates displayed by the display for purchaser, the second display control unit notifies, on the display for store clerk, that the commodity candidate matching the designated condition is selected.

3. The apparatus according to claim 2, wherein the second display control unit acquires, from an external apparatus, a file in which the designated condition is stored.

4. The apparatus according to claim 1, wherein
the second display control unit selectively displays, on the display for store clerk, an image of the commodity candidate selected by the first operation unit and an image of a commodity candidate other than the selected commodity candidate, and
the output unit outputs information concerning a commodity decided when the second input receiving unit receives decision operation for the commodity candidate selected by the first operation unit or decision operation for the commodity candidate other than the commodity candidate selected by the first operation unit.

5. The apparatus according to claim 1, wherein the first display control unit selectively displays the commodity candidates and displays unit prices of the commodity candidates in association with the commodity candidates.

6. An information processing, method by an information processing apparatus comprising:
extracting, on the basis of similarities between an image of a commodity picked up by an image pickup unit and reference images of commodities, candidates for the commodity subjected to the image pickup;
selectably displaying the commodity candidates on a display for purchaser;
receiving selection of a commodity candidate out of the commodity candidates via a first operation unit;
displaying, on a display for store clerk different from the display for purchaser, a screen for indicating which commodity candidate is selected and receiving a decision input of the commodity candidate;
receiving the decision input of the commodity candidate via a second operation unit different from the first operation unit; and
outputting information concerning the commodity candidate decided by the received decision input of the commodity candidate.

7. The method according to claim 6, further comprising notifying, when selection of a commodity candidate matching a designated condition out of the commodity candidates displayed by the display for purchase is received, on the display for store clerk, that the commodity candidate matching the designated condition is selected.

8. The method according to claim 7, further comprising acquiring, from an external apparatus, a file in which the designated condition is stored.

9. The method according to claim 6, further comprising:
selectively displaying, on the display for store clerk, an image of the commodity candidate selected by the first operation unit and an image of a commodity candidate other than the selected commodity candidate; and
outputting information concerning a commodity decided when decision operation for the commodity candidate selected by the first operation unit or decision operation for the commodity candidate other than the commodity candidate selected by the first operation unit is received.
